(19) United States
(12) Patent Application Publication
(10) Pub. No.: US 2010/0132109 A1
(43) Pub. Date: Jun. 3, 2010

(54) BATHTUB WITH CUSHION AND PREPARATION METHOD THEREOF

(75) Inventors: Kyung-Jun Kim, Seoul (KR); Jong-Kwan Lee, Kimpo-City (KR); Kyung-Jun Kim, Seoul (KR)

Correspondence Address: LEXYOUME IP GROUP, LLC, 5180 PARKSTONE DRIVE, SUITE 175, CHANTILLY, VA, 20151, US

(73) Assignee: Kyung-Jun Kim, Seoul (KR)

(21) Appl. No.: 12/481,182

(22) Filed: Jun. 9, 2009

(30) Foreign Application Priority Data
Dec. 1, 2008 (KR) 10-2008-0120258
Apr. 22, 2009 (KR) 10-2009-0034864

(51) Int. Cl. A47K 3/02; B29C 41/02

(52) U.S. Cl. 4/584; 264/46.4

(57) ABSTRACT

The present invention relates to a bathtub with cushion and a preparation method thereof which comprises an external structure layer which forms an external appearance of the bathtub; a foaming layer which is formed on the external structure layer; and a elastic protecting layer which is selected from groups of a rapid-hardening polyurea resin hardened layer, a polyurethane-urea resin hardened layer and an unfoaming painted layer, on the foaming layer.

### CROSS-REFERENCE TO RELATED APPLICATION

This application claims priority from Korean Patent Applications No. 2008-0120258, filed on Dec. 1, 2008 and No. 2009-0034864, filed on Apr. 22, 2009 in the Korean Intellectual Property Office, the disclosure of which is incorporated herein by reference.

### BACKGROUND OF THE INVENTION

1. Field of the Invention

The present invention relates to a bathtub with cushion and a preparation method thereof, and more particularly, to a bathtub with cushion and a preparation method thereof which provides good feeling of touch in an internal surface of the bathtub, feeling of comfort with cushion, secures safety with a cushion material with respect to shock, does not need to supplement water during bath by keeping water warm, provides a bathtub with cushion that can be used as a baby's bed or cradle after the bath if used as a baby's bathtub and greatly improves productivity of the bathtub with cushion by reducing forming time of a elastic protecting layer which causes production deterioration in related art.

2. Description of the Related Art

Generally, a bathtub is classified into a portable type and a fixed type. The former is mainly used for babies and prepared with hard plastic such as polyethylene or polypropylene ABS resin. That is, the method of preparing a conventional hard plastic bathtub includes a mold opening method and an injection mold by molding resin including polyethylene or polypropylene ABS resin added with a hardener. In case of a fixed bathtub, it is classified into an artificial marble bathtub prepared by molding unsaturated polyester resin and an acryl bathtub by vacuum-shaping an acryl layer.

The conventional method of preparing the bathtub enables to provide a low-cost, light tub, which, however, deteriorates a sense of touch, is not good for skin, does not keep water warm, causing a user to supplement water during bath. Such a problem becomes worse when infants or babies are given a bath. Moreover, the hard bathtub may cause safety accidents if a user collides with the bathtub or fall over the bathtub with great shock. To improve such a problem, a bathtub with elasticity or cushion has been developed.

Generally, the bathtub with cushion is configured to sequentially have a cushion surface coating layer, an elastic protecting layer, a foam layer and an external structure body layer. The cushion coating layer has a thickness of about 0.05 mm to 0.3 mm, the elastic protecting layer about 1 mm to 5 mm, and the foam layer about 5 mm to 50 mm. The three layers are secured and protected from external shock by the hard external finishing layer, which has a thickness of 2 mm to 20 mm.

In the preparation method of the bathtub with cushion, the cushion surface coating layer is formed by releasing mold on an upper surface of a male mold formed by FRP with oil-based or water-based acrylurethane resin or polyurethane resign and then by air-spraying. It is important to make an external surface of the cushion surface coating layer beautiful since it forms the external surface layer. Thus, it should be coated as a thin layer of 0.05 mm to 0.3 mm to solve problems such as a pinhole, a failure to harden, inter-layer exfoliation, surface crack, etc. which can occur when the coating layer is thick. To protect the thin cushion surface coating layer, the elastic protecting layer is formed right below the cushion surface coating layer. A conventional protecting layer includes natural rubber, plastics, i.e., natural latex or artificial latex including natural rubber or synthetic rubber emulsified with water or melted by solvent to be air-sprayed and hardened. To avoid problems such as inter-layer exfoliation or failure to harden due to too much application volume, the elastic protecting layer was applied with a thin thickness of 0.1 mm to 0.3 mm for one-time and hardening time is long.

However, the elastic protecting layer should have a thickness of about 1 mm to 5 mm to display its inherent function like waterproof and protection of the cushion surface coating layer. To obtain such thickness, the elastic protecting layer should have several rounds of coating and hardening. As a result, the preparation process of the bathtub with cushion is very long and a single mold only produces about two bathtubs a day. With ailing productivity, production costs are on the rise and goods supply is not smooth. And repetitive processes make production control difficult, causing problems like a failure to harden, forming failures, layer separations, etc.

Thus, it is required to develop a bathtub and a preparation method thereof which solves the foregoing problems as well as realizing advantages of a conventional bathtub with cushion.

### SUMMARY OF THE INVENTION

Accordingly, it is an aspect of the present invention to provide a bathtub with cushion and a preparation method thereof which provides good sense of touch in an internal surface of the bathtub, feeling of comfort with cushion, secures safety with a cushion material with respect to shock, does not need to supplement water during bath by keeping water warm, provides a bathtub with cushion that can be used as a baby's bed or cradle after the bath if used as a baby's bathtub and greatly improves productivity of the bathtub with cushion by reducing forming time of a elastic protecting layer which causes production deterioration in related art.

The foregoing and/or other aspects of the present invention can be achieved by providing a bathtub with cushion comprising an external structure layer which forms an external appearance of the bathtub; a foaming layer which is formed on the external structure layer; and a elastic protecting layer which is selected from groups of a rapid-hardening polyurea resin hardened layer, a polyurethane-urea resin hardened layer and an unfoaming painted layer, on the foaming layer.

Preferably, the elastic protecting layer comprises i) an unfoaming painted layer forming a semi-rigid layer, ii) a hardened layer of a coating composing for forming the elastic protecting layer comprising a) a major material of 40 wt % to 60 wt % having polyamine of 50 wt % to 90 wt % having 2 or 3 ammonia groups in an end and a cross-linker of 1 wt % to 35 wt % and b) polyurea resin comprising a polyisocyanate hardener of 40 wt % to 60 wt %, or iii) a hardened layer of a coating composing for forming the elastic protecting layer comprising a) a major material of 40 wt % to 60 wt % having polypropylene glycol of 40 wt % to 70 wt % having 2 or 3 hydroxyl groups in an end, a cross-linker of 1 wt % to 35 wt % and a catalyst of 0.1 wt % to 10 wt %; and b) polyurethane-urea resin comprising a polyisocyanate hardener of 40 wt % to 60 wt %.

The foregoing and/or other aspects of the present invention can be achieved by providing a preparation method of a bathtub comprising a first operation of forming an external structure layer forming an external appearance of the bathtub; a second operation of forming a mold-release agent layer having a bathtub forming surface corresponding to an internal shape of the bathtub and a flange extending from a circumference of the bathtub forming surface to the outside, on an external surface of an internal mold; and a third operation of forming a semi-rigid foam layer having a soft foam layer and an unfoaming painted layer formed sequentially between the external structure layer and the mold-release agent layer by being injected in a space between the external structure layer and the mold-release layer.

The foregoing and/or other aspects of the present invention can be achieved by providing a preparation method of a bathtub with cushion in which a cushion surface coating layer, a elastic protecting layer, a foam layer and an external structure layer are sequentially formed from an internal surface, the preparation method comprising forming a elastic protecting layer with a hardened layer comprising a rapid-hardening polyurea resin or polyurethane-urea resin.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is a perspective view of illustrating a preparation method of a bathtub with cushion according to a first exemplary embodiment of the present invention;

FIG. 2 is a sectional view of the bathtub with cushion according to the first exemplary embodiment of the present invention;

FIG. 3 is a perspective view of illustrating a preparation method of a bathtub with cushion according to second and third exemplary embodiments of the present invention;

FIG. 4 illustrates a half-made bathtub according to another exemplary embodiment of the present invention; and

FIG. 5 illustrates a finishing process of the preparation method of the bathtub with cushion according to the second and third exemplary embodiments of the present invention.

### DETAILED DESCRIPTION OF EXEMPLARY EMBODIMENT

Hereinafter, exemplary embodiments of the present invention will be described with reference to accompanying drawings, wherein like numerals refer to like elements and repetitive descriptions will be avoided as necessary.

In the present invention, “an unfoaming painted layer” includes a semi-rigid foam layer which is typically called integral skin foam, and refers to a painted layer formed on a soft foam layer.

Hereinafter, a semi-rigid foam bathtub with cushion according to a first exemplary embodiment of the present invention which sequentially includes a soft foam layer and an unfoaming painted layer having the foam layer and the elastic protecting layer will be described. Then, a bathtub with cushion according to second and third exemplary embodiments of the present invention which includes a rapid-hardening polyurea resin hardened layer and a polyurethane-urea resin hardened layer as the elastic protecting layer formed on the foam layer will be described.

Hereinafter, a bathtub with cushion which includes a semi-rigid foam according to the first exemplary embodiment of the present invention will be described.

The bathtub with cushion according to the first exemplary embodiment of the present invention may be formed by a first operation which forms an external structure layer forming an external appearance of a bathtub; a second operation which forms a mold-release layer on an external surface of an internal mold having a bathtub forming surface corresponding to an internal shape of a bathtub and a flange extending from a circumference of the bathtub forming surface; and a third operation which forms a semi-rigid foam layer having a soft foam layer and an unfoaming painted layer sequentially formed between the external structure layer and the mold-release layer by injecting a semi-rigid foam in a space formed between the external structure layer and the mold-release layer.

The first operation which will be described later may be performed after the semi-rigid foam layer is foamed. Thus, the order of the operations is not limited to the foregoing, and may vary as long as those operations are all performed.

Each operation will be described in detail. The first operation is an operation which forms an external structure layer 4 having an external appearance of a bathtub. The external structure layer forms an external surface of a bathtub and acts as a structure of the bathtub. The external structure layer may be formed by using a rigid resin material typically used for preparing a rigid bathtub. In case of preparing a portable baby bathtub, a mold opening method and an injection mold by molding resin including polyethylene or polypropylene ABS resin added with a hardener may be used. More specifically, a rigid material should be used to maintain the shape of the bathtub. More preferably, general plastics such as PS, PE, PP, acryl, ABS, PVC and PET, which are soft enough to overcome falling shock or external shock to some degree, may be used. The external structure layer is prepared by vacuum-forming a plastic shaped like a sheet in a thickness of 2 mm to 5 mm with a typical vacuum forming machine. In case of a fixed type bathtub, RFP including unsaturated polyester resin and glass fiber is used to prepare a 4 mm-5 mm external structure layer or an acryl sheet in a thickness of 4 mm to 5 mm is vacuum-formed to prepare the external structure layer. Here, the external structure layer should form an external appearance of the bathtub and an unnecessarily-extended part thereof should be removed through a post processing.

The second operation is an operation which forms a mold-release layer on an external surface of an internal mold having the bath forming surface corresponding to the internal shape of the bathtub and a flange extended from a circumference of the bath forming surface.

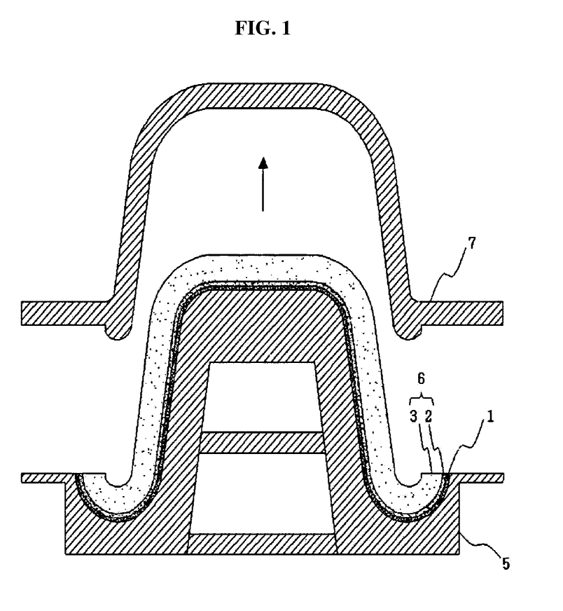

As shown in FIG. 1, the mold includes the bath forming surface and the flange extending from the circumference of the bath forming surface to the outside (left and rights sides in the drawing), which refers to a male bathtub mold 5 including FRP material or metal material used typically in the bathtub industry. As shown in FIG. 1, a rear surface of the male bathtub mold 5 is applied with a mold-release agent such as wax for mold-releasing treatment to form a mold-release agent layer 1.

On the mold-release layer 1 may be formed a cushion surface coating layer (not shown) which forms a surface of a cushion and has good gloss, elasticity and anti-scratch, wherever necessary. That is, the cushion surface coating layer may be formed on the mold-release agent layer formed from the foregoing process. More specifically, the cushion surface coating layer is formed by applying and drying a solvent type acrylpolyurethane coating agent, or a water-based or oil-based polyurethane coating layer. Preferably, the cushion material forming the cushion surface coating layer includes a soft resign which has at least 50% extension rate when fractured. The cushion surface coating layer may be applied to the flange to form an extension part of the semi-rigid foam layer or may be shorter than that. For example, the cushion surface coating layer may be formed to an front end of the flange to allow a curved surface to be the extension part.

According to the first exemplary embodiment of the present invention, the semi-rigid foam layer 6 which has an existing elastic protecting layer and the foam layer is formed at the third operation. Such a semi-rigid foam layer is typically called an integral skin foam (hereinafter, to be called “ISF”).

According to the first exemplary embodiment of the present invention, the ISF layer may be prepared by using HA-7150 and RSA-76 of Korea Polytech Co., Ltd. The ISF layer includes a typical polyurethane semi-rigid foam and the forming density is about 150-400 kg/m³, and its surface hardness is preferably Shore C=30−70 for cushion and costs. The ISF layer may be formed by mixing semi-rigid polyurethane foam material by a typical agitating method, i.e., with an agitator at 3,000 to 5,000 RPM or injecting the material to the mold after mixing the material with a low-temperature foaming machine or a high-temperature foaming machine.

The material which is used for forming the ISF layer includes a major material and a hardener which can be mixed at the rate of 100 wt % to 30-100 wt %.

The major material includes polyetherpolyol; polymerpolyol in which a monomer of acrylonitrile or styrene-acrylonitrile; a catalyst; a foaming agent; and a liquid mixture uniformly including a chain extender or surfactant as necessary.

Polyesterpolyol may include 2-3 OH functional groups and 40 wt % to 100 wt % with molecular weight of 3,000 to 10,000.

Polymerpolyol includes acrylonitrile or styrene-acrylonitrile monomers of 10 wt % to 45 wt % and hydroxyl value of 20 to 60 mgKOH/g with 0 wt % to 60 wt %.

The chain extender may include dihydric alcohol, e.g., ethylene glycol, diethylene glycol, dipropyleneglycol, diethanolamine or triethanolamine of 0 wt % to 15 wt %.

The surfactant may include, e.g., tertiary amine of 0.1 wt % to 5.0 wt %.

The foaming agent may include a chemical foaming agent which includes water or carbonyl acid in the range of 0 wt % to 1.0 wt %. A physical foaming agent may include CFC-11, HCFC-141b, pentane, methylene chloride or hydrofluorocarbon of 0.1 wt % to 40 wt %.

The hardener may include a liquid mixture, including NCO % of 20 wt % to 35 wt %, which is made by mixing isocyanate compound and alcohol and then reacting the mixture at 80° C. for at least two hours.

The isocyanate compound may include methylene diphenyl diisocyanate (MDI), toluene diisocyanate (TDI), or isocyanate mixed with MDI and TDI.

Alcohol may include 2-3 OH functional groups, and 2 wt % -15 wt % polyol having molecular weight of 200 to 6,000 or dihydric alcohol monomer or trihydric alcohol monomer of 0.1 wt %-10 wt %.

To form a color ISF layer, 100 wt % HAS-9175 of Korea Polytech Co., Ltd. may be added with 0.5 wt % to 4 wt % color pigment to be agitated. The color pigment may include typically an oil-based product.

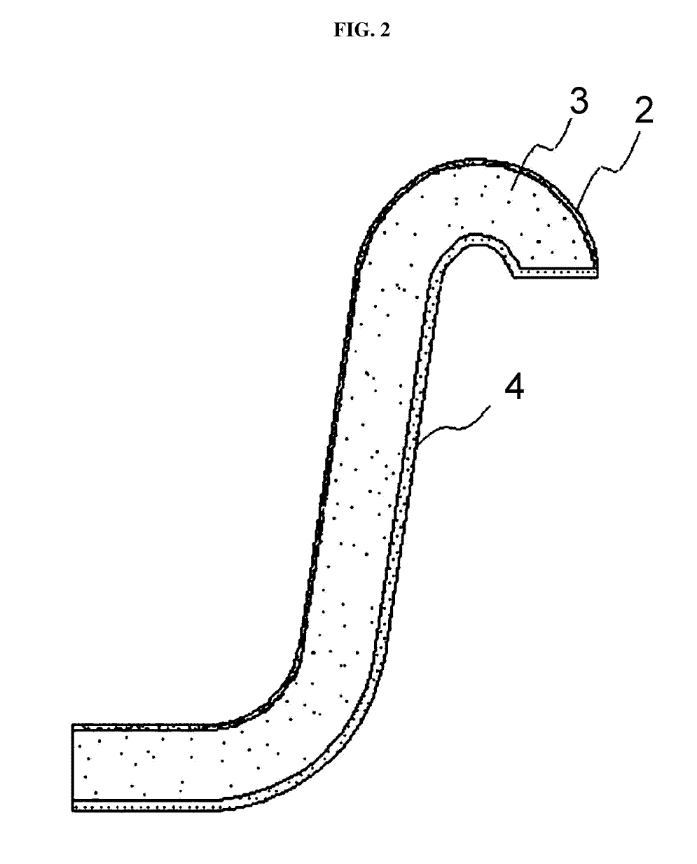

Similarly to the method of connecting typical upper/lower molds and injecting foaming agent in the space thereof, the semi-rigid foam layer 6 may be formed by connecting the mold having the external structure layer 4 and the mold 5 having the mold-release layer and by injecting the foregoing materials in the space thereof, or by connecting the external structure layer 4 separated from the mold and the mold applied with the mold-release agent and by injecting the materials in the space thereof. Here, the temperature of the respective molds preferably maintains 30° C. to 60° C. for quality. As shown in FIG. 1, an external mold 7 which is mold-released is fitted into the internal mold applied with the mold-release agent and then the semi-rigid foam layer is formed by the foregoing materials. If the external mold is separated, the shape as in FIG. 2 may be obtained. The bathtub as shown in FIG. 2 may be prepared by connecting the external structure layer 4 with the semi-rigid foam layer formed as above.

The surface of the semi-rigid foam layer or the ISF layer contacting the internal surface of the mold has a thickness of 0.3 mm to 3 mm and includes the unfoaming painted layer 2 and the soft foam layer 3 with cushion as an internal layer. Thus, the conventional elastic protecting layer and the foaming layer of the bathtub with cushion may be formed by a single process. The polyurethane material used for forming the semi-rigid foam layer is relatively cheaper than the rapid-hardening elastic protecting layer.

The bathtub with cushion according to the first exemplary embodiment of the present invention includes the external structure layer having an external appearance of the bathtub; and the semi-rigid foam layer including the soft foam layer and the unfoaming painted layer sequentially formed on the external structure layer. The example of the external structure layer and the semi-rigid foam layer are as shown in FIG. 2. The bathtub which has the foregoing configuration may be prepared by the foregoing preparation method or any other preparation method. The bathtub includes all of typical bathtubs including a fixed type and a portable type, and preferably a baby bathtub since it can enhance purposes and efficiencies of the bathtub.

Hereinafter, a bathtub which has a rapid-hardening polyurea resin hardened layer and a polyurethane-urea resin hardened layer as the elastic protecting layer according to second and third exemplary embodiments of the present invention will be described in detail.

The bathtub with cushion according to the second and third exemplary embodiments of the present invention includes a cushion surface coating layer, a elastic protecting layer, a foam layer and an external structure layer formed sequentially from the internal surface. The elastic protecting layer includes a rapid-hardening polyurea resin or polyurethane-urea resin hardened layer.

In a preparation method of the bathtub with cushion including the cushion surface coating layer, the elastic protecting layer, the foam layer and the external structure layer according to the second and third exemplary embodiments of the present invention, the elastic protecting layer including polyurea resin or polyurethane-urea resin hardened layer may be formed by the preparation method of the bathtub with cushion.

The cushion surface coating layer, the foam layer and the external structure layer excluding the elastic protecting layer may be prepared by known methods.

Preferably, the elastic protecting layer according to the present invention may include:

a) a major agent of 40 wt % to 60 wt % including polyamine of 50 wt % to 90 wt % with 2 or 4 ammonia groups in an end and a cross-linker of 1 wt % to 35 wt %; and b) a hardened layer of a coating composition including polyurea resin with polyisocyanate hardener of 40 wt % to 60 wt % for forming the elastic protecting layer (first exemplary embodiment); or

a) a major agent of 40 wt % to 60 wt % including polypropylene glycol (polyol) of 40 wt % to 70 wt % with 2 or 3 hydroxyl groups in an end, a cross-linker of 1 wt % to 35 wt % and a catalyst of 0.1 wt % to 10 wt %; and b) a hardened layer of a coating composition including polyurethane-urea resin with polyisocyanate hardener of 40 wt % to 60 wt % for forming the elastic protecting layer (second exemplary embodiment). The coating composition including polyurea resin for forming the elastic protecting layer may further include a catalyst of 0.001 wt % to 5.0 wt %. The coating composition including polyurethane-urea resin for forming the elastic protecting layer may further include polyamine of 0.01 wt % to 30 wt % having 2 or 3 ammonia groups in an end.

If the components of the coating composition for forming the elastic protecting layer is within the foregoing content, one-time application volume may be 0.5 mm to 2.5 mm, more preferably, 0.5 mm to 1 mm and the property of the hardened layer is excellent and the hardening time may be reduced. Also, the hardened layer has at least 100% extension rate, and more preferably, 100% to 200% extension rate when fractured.

Polyamine which has 2 or 3 ammonia groups (NH2) in an end of the coating composition for forming the elastic protecting layer may include molecular weight of 400 to 6,000 while polypropylene glycol (polyol) having 2 or 3 hydroxyl groups in an end may include molecular weight of 1,000 to 10,000. The cross-linker may include diethyltoluene diamine (DETDA), MOCA, ethylene glycol (EG), diethylene glycol (DEG), dipropylene glycol (DPG), diethanol amine (DEOA) or triethanol amine (TEOA) or a mixture including at least two of the foregoing. The catalyst may include tertiary amine or organic metal typically used for polyurethane reaction. More specifically, the catalyst may include Pb octate, tin octate, potassium octate, calcium octate, bismuth neodecanoate, etc.

The coating composition for forming the elastic protecting layer may further include a silane coupling agent of 0.01 wt % to 3 wt % as necessary. For example, the coating composition may further include amino, epoxy, etc. In this case, adhesiveness may further improve.

Polyisocyanate which is used as the hardener may include a prepolymer having isocyanate of 5 wt % to 20 wt %. Commercial polyisocyanate may be used, or isocyanate (NCO) compound may be reacted with polypropylene glycol or polyamine. A viscosity of the polymer is preferably 500 cps to 2500 cps at 25° C. The isocyanate compound may include monomeric methylene diphenyl diisocyanate (M-MDI), polymeric diphenyl diisocyanate (P-MDI), toluene diisocyanate (TDI) as aromatic isocyanate compound, or HDI, IPDI, NBDI, H12MDI NDI as alphatic isocyanate. Polypropylene glycol may include 2 or 3 hydroxyl groups in an end and have a molecular weight of 500 to 5,000. Preferably, the hardener may be prepared by mixing MDI or TDI of 30 wt % to 60 wt %, polypropylene glycol of 40 wt % to 60 wt %, or polyamine of 40 wt % to 60 wt % with the cross-linker of 0.1 wt % to 1 wt % and reacting the mixture at reaction temperatures of 60° C. to 100° C. for 1 to 10 hours with a reflux reactor. The coating composition including polyurethane resin for forming the elastic protecting layer is more expensive than the coating composition including polyurethane-urea resin for forming the elastic protecting layer, but has a more rapid hardening rate and better physical strength.

The preparation method of the bathtub with cushion according to the second and third exemplary embodiments of the present invention may apply a known preparation method of the bathtub with cushion and may include a method of forming the elastic protecting layer by using the coating composition including the rapid-hardening polyurea resin for forming the elastic protecting layer or the coating composition including polyurethane-urea resin for forming the elastic protecting layer.

The preparation method of the bathtub with cushion according to the second and third exemplary embodiments of the present invention may include a first operation which forms an external structure layer forming an external appearance of a bathtub; a second operation which forms a elastic protecting layer by forming a bathtub forming surface corresponding to an internal shape of the bathtub and a mold-release layer on an external surface of an internal mold, forming a cushion surface coating layer on the mold-release agent layer, and coating and hardening the coating composition including the rapid-hardening polyurea resin forming the elastic protecting layer or the coating composition including the polyurethane-urea resin for forming the elastic protecting layer on the cushion surface coating layer; and a third operation which forms a foam layer connecting the external structure layer and an internal cushion layer by being injected in a space between the external structure layer and the internal cushion layer (a stacking structure of the cushion surface coating layer and the elastic protecting layer).

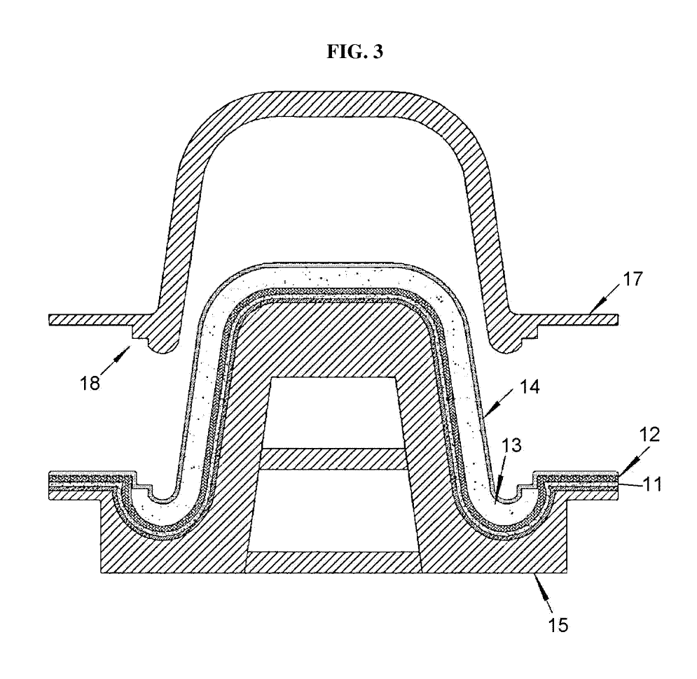

Preferably, the preparation method of the bathtub with cushion according to the second and third exemplary embodiments of the present invention may include a first operation which forms an external structure layer 14 forming an external appearance of the bathtub; a second operation which forms a mold-release agent layer, on an external surface of an internal mold, having a bathtub forming surface corresponding to an internal shape of the bathtub and a flange extending from a circumference of the bathtub forming surface to the outside, forming a cushion surface coating layer 11 on the mold-release agent layer and forming an internal cushion layer including the internal shape of the bathtub and the extension part extending from the circumference of the internal shape of the bathtub to the outside by forming the elastic protecting layer 12 which is prepared by coating and hardening the coating composition including the rapid-hardening polyurea resin for forming the elastic protecting layer or the coating composition including polyurethane-urea resin for forming the elastic protecting layer on the cushion surface coating layer 11; a third operation which forms a foam layer 13 connecting the external structure layer and an internal cushion layer by being injected in a space between the external structure layer and the internal cushion layer (a stacking structure of the cushion surface coating layer 11 and the elastic protecting layer 12); and a fourth operation which folds the extension part of the internal cushion layer toward the circumference of the external structure layer 14 and adhering the external structure layer 14. The operations will be described with reference to FIGS. 3 to 5.

The order of the first and second operations may be interchanged, and the first operation which will be described later may be performed after the foam layer is foamed at the third operation. The order of the operations may vary as long as they are performed all (provided, however, that the fourth operation is performed lastly).

Each operation will be described in detail. The first operation is an operation which forms an external structure layer 14 having an external appearance of a bathtub. The external structure layer forms an external surface of a bathtub and acts as a structure of the bathtub. The external structure layer may be formed by using a rigid resin material typically used for preparing a rigid bathtub. In case of preparing a portable baby bathtub, a mold opening method and an injection mold by molding resin including polyethylene or polypropylene ABS resin added with a hardener may be used. More specifically, a rigid material should be used to maintain the shape of the bathtub. More preferably, general plastics such as PS, PE, PP, acryl, ABS, PVC and PET which are soft to overcome falling shock or external shock to some degree may be used. The external structure layer is prepared by vacuum-forming a plastic shaped like a sheet in a thickness of 2 mm to 5 mm with a typical vacuum forming machine. In case of a fixed type bathtub, RFP including unsaturated polyester resin and glass fiber is used to prepare a 4 mm-5 mm external structure layer or an acryl sheet in a thickness of 4 mm to 5 mm is vacuum-formed to prepare the external structure layer. Here, the external structure layer should form an external appearance of the bathtub and an unnecessarily-extended part thereof should be removed through a post processing.

The second operation is an operation which forms an internal cushion layer having the internal shape of the bathtub and the extension part extending from the circumference of the internal shape of the bathtub to the outside by forming a mold-release agent layer on an external surface of an internal mold having the bath forming surface corresponding to the internal shape of the bathtub and a flange extending from a circumference of the bath forming surface to the outside, forming the cushion surface coating layer 11 on the mold-release agent layer, and forming the elastic protecting layer 12 on the cushion surface coating layer 11 by coating and hardening the coating composition including the rapid-hardening polyurea resin for forming the elastic protecting layer or the coating composition including polyurethane-urea resin for forming the elastic protecting layer.

As shown in FIG. 3, the mold includes the bath forming surface and the flange extending from the circumference of the bath forming surface to the outside (left and rights sides in the drawing), which refers to a male bathtub mold 15 including FRP material or metal material used typically in the bathtub industry. As shown in FIG. 3, a rear surface of the male bathtub mold 5 is applied with a mold-release agent such as wax for mold-releasing treatment to form a mold-release layer (a layer formed between the mold 15 and the cushion surface coating layer 11).

On the mold-release layer 1 may be formed a cushion surface coating layer 11 which forms a surface of a cushion and has good gloss, elasticity and anti-scratch. The cusion surface coating layer 11 may have a thickness of 0.05 mm to 0.3 mm. That is, the cushion surface coating layer 11 may be formed on the mold-release layer formed from the foregoing process. More specifically, the cushion surface coating layer is formed by applying and drying a solvent type acrylpolyurethane coating agent, or water-based or oil-based polyurethane coating layer on the mold-release layer. Preferably, the cushion material forming the cushion surface coating layer includes a soft resign which has at least 50% extension rate when fractured. The cushion surface coating layer may be applied to the flange to form an extension part of the internal cushion layer or may be shorter than that. For example, the cushion surface coating layer may be formed to a front end of the flange to allow a curved surface to be the extension part.

To form the elastic protecting layer 12, a painted layer is formed on the cushion surface coating layer 11. That is, if a bathtub with cushion which has only a surface coating layer is used, the cushion surface coating layer 11 is thin and easily damaged. To protect the surface layer and form a waterproof layer of the foam layer 13, the elastic protecting layer 12 is formed. The coating composition including the rapid-hardening polyurea resin or polyurethane-urea resin for forming the elastic protecting layer is applied by a spray device. Preferably, the coating composition which has at least 100% extension rate, and more preferably, 100% to 200% extension rate when fractured is appropriate as the soft protection layer of the bathtub with cushion. The elastic protecting layer may be applied to the flange to form an extension part of the internal cushion layer or may be shorter than that. For example, the elastic protecting layer may be formed to a front end of the flange to allow a curved surface to be the extension part. The applied surface of the elastic protecting layer and the cushion surface coating layer does not need to be the same. The coating thickness of the coating composition for forming the elastic protecting layer may be adjusted by those skilled in the art, but may be 0.5 mm to 2.5 mm for one time, and preferably, 0.5 mm to 1 mm. The elastic protecting layer may have an overall thickness of 1 mm to 5 mm.

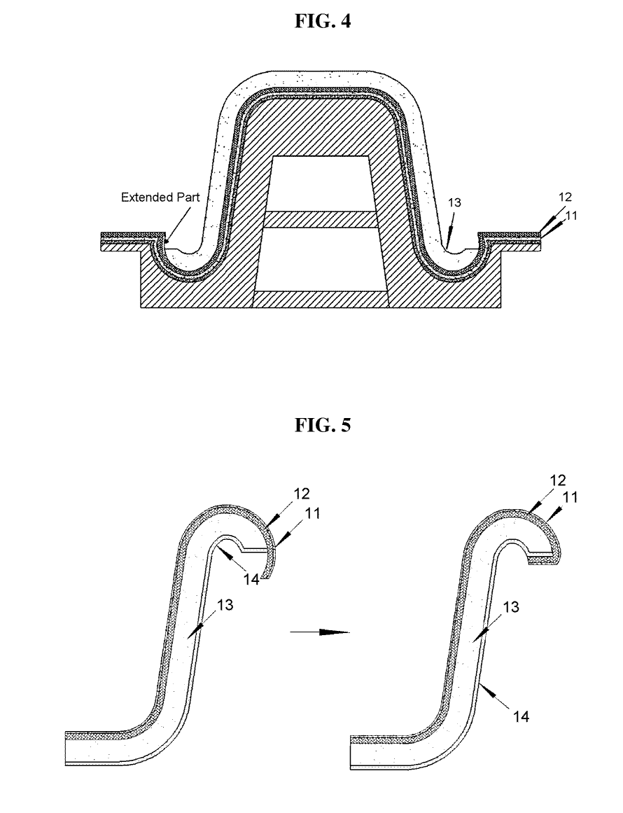

The third operation is an operation which forms a foam layer 13 connecting the external structure layer and an internal cushion layer by being injected in a space between the external structure layer and the internal cushion layer (a stacking structure of the cushion surface coating layer 11 and the elastic protecting layer 12). Similarly to the method of connecting typical upper/lower molds and injecting a foaming agent in the space thereof, the foam layer 13 may be formed by connecting the mold having the external structure layer 14 and the mold 15 having the internal cushion layer (a stacking structure of the cushion surface coating layer 11 and the elastic protecting layer 12) and by injecting the foregoing materials in the space thereof, or by connecting the external structure layer 14 separated from the mold and the mold having the internal cushion layer (a stacking structure of the cushion surface coating layer 11 and the elastic protecting layer 12) and by injecting a foaming agent in the space thereof. The foaming agent may include polyurethane, etc. As shown in FIG. 4, an external mold 17 which is mold-released (preferably, including a projection 18 in a circumference) is fitted into the internal cushion layer and then the foam layer is formed by a foaming agent. If the external mold 17 is separated, the shape as in FIG. 4 may be obtained. A preliminary bathtub as shown in the left side of FIG. 2 may be prepared by connecting the external structure layer 14 with the foam layer formed as above. If the foaming is performed partly, a supplementary foaming operation is performed before the connection of the external structure layer to thereby form a uniform foaming layer. When the foaming layer is formed, an injection hole for a foaming agent or a hole for venting during the foaming operation is not needed thus a clean bathtub is prepared and an operation of processing such holes is not required.

Regardless of the forming method of the foaming layer 13, the preliminary bathtub formed as above has a configuration in which the extension part including the cushion surface coating layer and the internal cushion layer staking the elastic protecting layer on the circumference of the bathtub (here, the extension part may correspond to a part formed on an upper surface of the flange if an end part of the foaming layer is formed around the flange as in FIG. 3, or correspond to a part of the curved part if the end part of the foaming layer ends far below the flange as shown in FIG. 4) is projected.

At the fourth operation, the extension part of the internal cushion layer is folded to the circumference of the external structure layer 14 to adhere the external structure layer 14. The specific example of the foregoing process is as shown in FIG. 5. Thus, the elastic protecting layer 12 acting as a waterproof layer of the foaming layer 13 contacts the soft external structure layer 14 in a large area to secure connection force, improve waterproof effect, provide a beautiful external appearance by preventing the connection surface from appearing. To fold and roll the extension part easily, the height of the circumference of the foaming layer 13 is preferably lower than the upper surface of the extension part of the internal cushion layer as shown in FIGS. 3 to 5. If the end part of the foaming layer is formed up to the flange, the part formed in the upper surface of the flange may become the extension part as shown in FIG. 3. If the end part of the foaming layer ends far below the flange as shown in FIG. 4, a part of the end part of the curved part may become the extension part.

The preparation method of the bathtub with cushion according to the second and third exemplary embodiments of the present invention includes forming the elastic protecting layer with the coating composition and then hardening the elastic protecting layer for about 2 minutes. The elastic protecting layer is easily hardened when the application thickness for one time is about 2 mm. In such a case, inter-layer exfoliation does not occur and thus a bathtub with cushion may be prepared as much as four times the conventional output volume, i.e., two bathtubs a day with a single mold. Thus, productivity of preparing the bathtub with cushion may greatly improve.

As described above, a bathtub with cushion and a preparation method thereof according to the present invention provides good sense of touch in an internal surface of the bathtub, feeling of comfort with cushion, secures safety with a cushion material with respect to shock, does not need to supplement water during bath by keeping water warm, provides a bathtub with cushion that can be used as a baby's bed or cradle after the bath if used as a baby's bathtub and greatly improves productivity of the bathtub with cushion by reducing forming time of a elastic protecting layer which causes production deterioration in related art.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A bathtub with cushion comprising:
an external structure layer which forms an external appearance of the bathtub;
a foaming layer which is formed on the external structure layer; and
a elastic protecting layer which is selected from groups of a rapid-hardening polyurea resin hardened layer, a polyurethane-urea resin hardened layer and an unfoaming painted layer, on the foaming layer.

2. The bathtub with cushion according to claim 1, wherein the foaming layer comprises a soft foam layer, the elastic protecting layer comprises an unfoaming painted layer and the soft foam layer and the unfoaming painted layer are formed sequentially to form a semi-rigid foam layer.

3. The bathtub with cushion according to claim 1, further comprising a cushion surface coating layer on the elastic protecting layer.

4. The bathtub with cushion according to claim 1, wherein the elastic protecting layer comprises a hardened layer of a coating composing for forming the elastic protecting layer comprising a) a major material of 40 wt % to 60 wt % having polyamine of 50 wt % to 90 wt % having 2 or 3 ammonia groups in an end and a cross-linker of 1 wt % to 35 wt %; and b) polyurea resin comprising a polyisocyanate hardener of 40 wt % to 60 wt %.

5. The bathtub with cushion according to claim 1, wherein the coating composition comprising polyurea resin for forming the elastic protecting layer further comprises a catalyst of 0.001 wt % to 5.0 wt %.

6. The bathtub with cushion according to claim 1, wherein the elastic protecting layer comprises a hardened layer of a coating composing for forming the elastic protecting layer comprising a) a major material of 40 wt % to 60 wt % having polypropylene glycol of 40 wt % to 70 wt % having 2 or 3 hydroxyl groups in an end, a cross-linker of 1 wt % to 35 wt % and a catalyst of 0.1 wt % to 10 wt %; and b) polyurethane-urea resin comprising a polyisocyanate hardener of 40 wt % to 60 wt %.

7. The bathtub with cushion according to claim 6, wherein the coating composition comprising polyurethane-urea resin for forming the elastic protecting layer further comprises polyamine of 0.01 wt % to 30 wt % having 2 or 3 ammonia groups in an end.

8. The bathtub with cushion according to claim 1, wherein the elastic protecting layer comprises a thickness of 1 mm to 5 mm.

9. A preparation method of a bathtub comprising:
a first operation of forming an external structure layer forming an external appearance of the bathtub;
a second operation of forming a mold-release agent layer having a bathtub forming surface corresponding to an internal shape of the bathtub and a flange extending from a circumference of the bathtub forming surface to the outside, on an external surface of an internal mold; and
a third operation of forming a semi-rigid foam layer having a soft foam layer and an unfoaming painted layer formed sequentially between the external structure layer and the mold-release agent layer by being injected in a space between the external structure layer and the mold-release layer.

10. The preparation method of the bathtub according to claim 9, further comprising forming a cushion surface coating layer on the mold-release layer.

11. A preparation method of a bathtub with cushion in which a cushion surface coating layer, a elastic protecting layer, a foam layer and an external structure layer are sequentially formed from an internal surface, the preparation method comprising forming a elastic protecting layer with a hardened layer comprising a rapid-hardening polyurea resin or polyurethane-urea resin.

12. The preparation method according to claim 11, further comprising:
a first operation of forming an external structure layer forming an external appearance of the bathtub;
a second operation of forming an internal cushion layer by forming a mold-release agent layer on an external surface of the mold corresponding to an internal shape of the bathtub, forming a cushion surface coating layer on the mold-release agent layer and forming a elastic protecting layer with rapid-hardening polyurea resin or polyurethane-urea resin on the cushion surface coating layer; and
a third operation of forming a foam layer connecting the external structure layer and an internal cushion layer by being injected in a space between the external structure layer and the internal cushion layer.

13. The preparation method according to claim 11, further comprising:
a first operation of forming an external structure layer forming an external appearance of the bathtub;
a second operation of forming an internal cushion layer having an internal shape of the bathtub and an extension part extending from a circumference of the internal shape of the bathtub to the outside by forming a mold-release agent layer having a bathtub forming surface corresponding to an internal shape of the bathtub and a flange extending from the circumference of the bathtub forming surface on an external surface of an internal mold, forming a cushion surface coating layer on the mold-release agent layer and forming a elastic protecting layer with rapid-hardening polyurea resin or polyurethane-urea resin on the cushion surface coating layer;
a third operation of forming a foam layer connecting the external structure layer and the internal cushion layer by being injected in a space between the external structure layer and the internal cushion layer; and
a fourth operation of folding the extension part of the internal cushion layer to the circumference of the external structure layer to be adhered to the external structure layer.

14. The preparation method according to claim 11, wherein the coating composition comprising the rapid-hardening polyurea resin or polyurethane-urea resin for forming the elastic protecting layer is applied to have a thickness of 0.5 mm to 2.5 mm for one time.
